(19) United States
(12) Patent Application Publication
(10) Pub. No.: US 2025/0363870 A1
(43) Pub. Date: Nov. 27, 2025

(54) AWARD COMPETITION ELIGIBILITY BASED ON LEADERBOARD RANKINGS OF SELECTED LEADERBOARDS

(71) Applicant: IGT, Las Vegas, NV (US)

(72) Inventors: Jeffery McIntosh, Dieppe (CA); Dwayne R. Nelson, Las Vegas, NV (US)

(21) Appl. No.: 18/672,447

(22) Filed: May 23, 2024

(51) Int. Cl. G07F 17/32

(52) U.S. Cl. CPC G07F 17/3279; G07F 17/3211; G07F 17/3258

(57) ABSTRACT

Systems and methods that enable multiple players to participate in one or more competitive opportunities to win an award in association with such players being associated with one or more designated positions of one or more selected leaderboards.

### BACKGROUND

In various embodiments, the systems and methods of the present disclosure enable multiple players to participate in one or more competitive opportunities to win an award in association with such players being associated with one or more designated positions of one or more selected leaderboards.

Gaming machines may provide players awards in primary games. Gaming machines generally require the player to place or make a wager to activate the primary game. The award may be based on the player obtaining a winning symbol or symbol combination and on the amount of the wager.

### BRIEF DESCRIPTION OF THE FIGURES

FIG. 1 is an example configuration of a plurality of leaderboards tracking different events that are associated with a plurality of progressive controllers that each maintain one or more progressive awards.

FIG. 2A is a flow chart of an example process for operating a system that facilitates selecting a leaderboard responsive to an award triggering event and causing an award to be provided to one or more players associated with one or more designated positions on the selected leaderboard.

FIG. 2B is a screenshot illustrating which players of a selected leaderboard are provided which awards following an occurrence of an award triggering event.

FIG. 3 is a flow chart of an example process for operating a system that facilitates selecting a leaderboard responsive to an award triggering event and enabling one or more players associated with one or more designated positions on the selected leaderboard to participate in a competition in which certain players have an advantage based on being associated with certain designated positions on the selected leaderboard.

FIG. 4 is a schematic block diagram of one embodiment of an electronic configuration of an example system of the present disclosure.

FIGS. 5A and 5B are perspective views of example alternative embodiments of an electronic gaming machine of the present disclosure.

FIG. 5C is a front view of an example personal gaming device of the present disclosure.

### DETAILED DESCRIPTION

In various embodiments, the systems and methods of the present disclosure enable multiple players to participate in one or more competitive opportunities to win an award in association with such players being associated with one or more designated positions of one or more selected leaderboards.

In certain embodiments, the system enables a plurality of players to participate in one or more qualifying competitions in which the system employs one or more leaderboards to display each player's progress in such qualifying competitions. In these embodiments, for each of a plurality of different players, the system tracks one or more events that occur in association with that player during one or more gaming sessions. The system further ranks the different players based on the tracked events and causes one or more display devices to display, via one or more leaderboards, a designated quantity of such ranked players. In other words, the system of certain embodiments enables a plurality of players to compete, via tracking occurrences of one or more events over one or more gaming sessions, and utilizes a leaderboard to display different players relative rankings in such qualifying competitions. In these embodiments, since different players have different gaming experiences during different periods of time, the quantity of tracked events that occur in association with the different players vary over time and, thus, the assigned ranking to the different players vary over time.

In certain embodiments, in addition to maintaining one or more leaderboards that display the tracked progress in one or more qualifying competitions, the system maintains one or more awards, such as one or more progressive awards. In certain embodiments, upon an occurrence of an award triggering event associated with a maintained award, the system causes that maintained award to be made available to one or more players selected from one or more of the maintained leaderboards. In certain such embodiments, a maintained award is associated with a particular leaderboard such that upon an award triggering event for that maintained award, the system selects, at least partially based on respective rankings of that particular leaderboard, a plurality of players to participate in a competition to win that maintained award. In certain other embodiments, the maintained award is not associated with any particular leaderboard such that upon an award triggering event for that maintained award, the system first selects one or more of the leaderboards and then selects, at least partially based on respective rankings of the selected leaderboards, a plurality of players to participate in a competition to win that maintained award. In these different embodiments, responsive to an award triggering event occurring for a particular award, the system utilizes one or more ranked positions of one or more leaderboards to determine which players compete against each other to win that particular award. Put differently, players compete in a qualifying competition to determine, based on relative leaderboard rankings, whether such players qualify to participate in another competition to win a triggered award.

In certain embodiments, in addition to utilizing one or more leaderboards to determine which players qualify to participate in one or more competitions for a particular award, responsive to an award triggering event occurring for a particular award, the system utilizes one or more ranked positions of one or more leaderboards to determine the relative odds of each player in the competition to win that particular award. In these embodiments, by providing certain higher ranked qualifying players an advantage (and/or providing certain lower ranking qualifying players a disadvantage), the system factors in each player's relative leaderboard ranking to at least partially influence how the competition unfolds. For example, upon a progressive award triggering event occurring in association with a maintained progressive award, the system selects the highest ranked player from each of a plurality of separate leaderboards tracking different events (or alternatively selects a plurality of the highest ranked players from a single leaderboard tracking occurrences of one event) and enables the selected players to participate in a competition to win the progressive award. In this example, the system provides the highest ranked selected player an advantage in the competition over the other selected players. As illustrated in this example, while a player's respective ranking on a leaderboard at a given point in time may earn them the opportunity to play for a progressive award (and, in certain instances garner them an advantage in such an opportunity), one or more additional determinations in the ensuing competition determine which of the players win the progressive award. As such, in addition to utilizing a leaderboard to display to different players (and passersby) the relative ranking of various players, the present disclosure employs the leaderboard ranking to select different ranked players to participate in a competition sequence to win an award exclusively available, subject to the outcome of the competition, to only certain ranked players.

Accordingly, unlike prior systems that operated in a static mode of operation in which the same progressive award is always available to all players, the system of the present disclosure employs various modes of operation by periodically providing that the same progressive award is only available to certain players based on those player's relative ranking on one or more leaderboards. For example, responsive to a first occurrence of a progressive award triggering event, the system operates in a first leaderboard exclusivity mode for the benefit of a certain group of players of at least a certain ranking of a first leaderboard and responsive to another occurrence of a progressive award triggering event, the system operates in a second leaderboard exclusivity mode for the benefit of another group of players of at least a certain ranking of a second, different leaderboard.

In addition to improving how the system operates by employing multiple different leaderboard exclusivity modes of operations, the system of the present disclosure introduces an improved user interface by employing one or more leaderboards to keep players aware of their relative progress in the competition sequence. In certain such embodiments, by maintaining multiple leaderboards that track different events and by selecting one or more of such leaderboards to determine which players are entitled to compete for a triggered award, the user interface of the system operates to invoke a degree by strategy or skill not otherwise seen from prior systems. That is, because players are unaware of which leaderboards will be selected and thus certain players need to know where they stand on the different leaderboards (as it pertains to how players change their interactions with the system to potentially move up one leaderboard at the expense of moving down another leaderboard), the user interface of certain embodiments of the system of the present disclosure cycles through the different leaderboards such that players are more cognizant of their respective rankings on the different available leaderboards.

While certain embodiments described below are directed to tracking events in association with a leaderboard and enabling multiple players to participate in one or more competitive opportunities to win a progressive award in association with such players maintaining one or more designated positions on the leaderboard, it should be appreciated that such embodiments may additionally or alternatively be employed in association with tracking events in association with a leaderboard and enabling multiple players to participate in one or more competitive opportunities to win a non-progressive award, such as static award or an award opportunity, in association with such players maintaining one or more designated positions on the leaderboard. Moreover, while certain embodiments described below are directed to tracking events in association with a leaderboard and enabling multiple players at multiple electronic gaming machines (such as, but not limited to, one or more slot machines, one or more video poker machines, one or more video lottery terminals, one or more terminals associated with an electronic table game, one or more terminals associated with a live table game, one or more video keno machines, one or more video bingo machines and/or one or more sports betting terminals that offers sports betting opportunities) to participate in one or more competitive opportunities to win a progressive award in association with such players maintaining one or more designated positions on the leaderboard, it should be appreciated that such embodiments may additionally or alternatively be employed in association with one or more personal gaming devices that enable online wagering and/or online social games (in which the system tracks events occurring in association with the online wagering and/or the online social games to determine leaderboard rankings and enables certain users to participate in one or more competitive opportunities to win an award in association with such users maintaining one or more designated positions on the leaderboard).

In certain embodiments, the system maintains one or more leaderboards. Each leaderboard includes a quantity of ranked positions. For each leaderboard, the ranked positions correspond to a relative order that different users, such as players, are ranked according to one or more criteria at different points in time. That is, as the respective rankings for different users may change throughout each user's participation in a gaming sequence, such as a tournament, the system utilizes a leaderboard to dynamically convey the users that are currently ranked (i.e., at that point in time) at the ranked positions that qualify for display on the leaderboard. As such, the system monitors for various activities occurring at a gaming establishment device, such as an electronic gaming machine, and/or remote from any gaming establishment device and determines, based on such tracked occurrences, the ranking of these users on one or more leaderboards.

In certain embodiments, the system includes or is otherwise associated with one or more leaderboard hosts which track one or more occurrences of one or more events and/or operate with one or more display devices, such as display devices of individual electronic gaming machines and/or gaming establishment overhead signs, to display the current state of one or more maintained leaderboards. In operation of such embodiments, a gaming establishment device, such as an electronic gaming machine or a slot machine interface board associated with an electronic gaming machine, reports data associated with tracked events occurring at that gaming establishment device to the leaderboard host. In these embodiments, the leaderboard host utilizes the reported data, along with data reported from zero, one or more other gaming establishment devices, to determine a current state of a maintained leaderboard. The leaderboard host then causes one or more display devices to display the current state of the maintained leaderboard such that different users of the gaming establishment devices, such as different players, as well as different bystanders, are aware of the current state of the maintained leaderboard.

In certain embodiments, in addition to (or alternative from) the system tracking one or more events to determine one or more rankings on one or more leaderboards, each individual gaming establishment device tracks one or more events and sends information associated with the tracked events to the system (upon a request from the system and/or at designated intervals) to enable the system to determine one or more rankings on one or more leaderboards. It should be appreciated that a player may change electronic gaming machines during the tracking of ranking component(s) and that the tracking of ranking component(s) can be independent of the specific electronic gaming machine. For example, the system tracks events on each electronic gaming machine by individual players through a player tracking system.

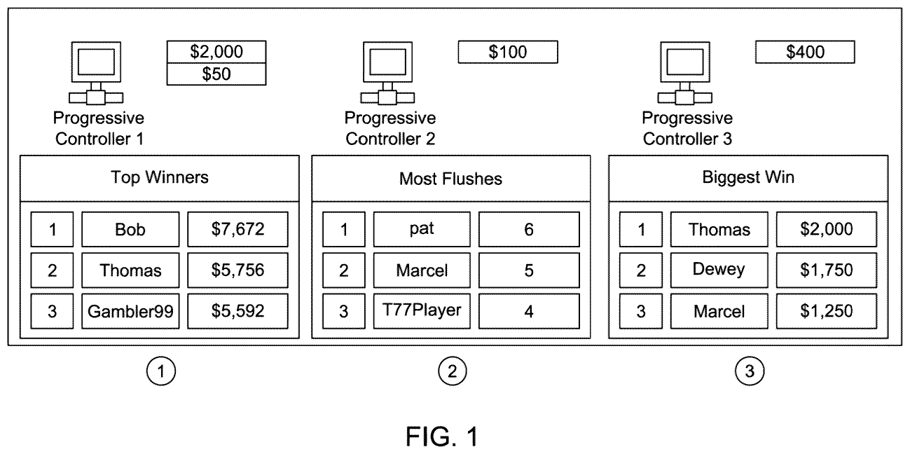

It should be appreciated that by displaying the different states of the different maintained leaderboards, certain users may alter how they behave relative to one or more gaming establishment devices. That is, by maintaining multiple leaderboards that track different events and by selecting, as described in more detail below, one or more of such leaderboards to determine which players are entitled to compete for a triggered award, the system operates to invoke a degree by strategy or skill as different users prioritize a ranking on one leaderboard over a ranking on another leaderboard. For example, as seen in FIG. 1 (which illustrates three different leaderboards which rank users based on occurrences of different tracked events and are each associated with one or more progressive awards maintained by one or more progressive controllers), in an effort to position themselves on a certain leaderboard associated with a certain progressive award, certain players may alter how they interact with the system, such as by forgoing a certain outcome tracked on a leaderboard associated with a relatively low valued progressive award in favor of attempting to obtain a larger win (and thus move up the rankings of another leaderboard which tracks another event and is associated with a relatively high valued progressive award). As illustrated by this example, because players are unaware of which leaderboards will be selected and thus certain players need to know where they stand on the different leaderboards (as it pertains to how players change their interactions with the system to potentially move up one leaderboard at the expense of moving down another leaderboard), the system displays, simultaneously or sequentially, the different leaderboards such that players are more cognizant of their respective rankings on the different available leaderboards.

In certain embodiments, in association with a leaderboard, the system tracks occurrences of a single event (i.e., a single ranking component) and employs the tracked occurrences of this single event to determine each participants relative ranking on that leaderboard. In these embodiments, one or more rankings of one or more users on the leaderboard are based on a single ranking component associated with that leaderboard. In certain embodiments, in association with a leaderboard, the system tracks occurrences of multiple events (i.e., multiple ranking components) and employs the tracked occurrences of these multiple events to determine each participants relative ranking on that leaderboard. In these embodiments, one or more rankings of one or more users on a leaderboard are based on a plurality of ranking components associated with that leaderboard. In certain such embodiments in which a leaderboard is associated with occurrences of multiple events, the system weighs each event equally such that each tracked event counts equally in the determination of a ranking of a user on the leaderboard. In certain other embodiments in which a leaderboard is associated with occurrences of multiple events, the system weighs each event unequally such that certain tracked events count more (or less) in the determination of a ranking of a user on the leaderboard.

In certain embodiments, one or more leaderboards correspond to one or more ranking components, such as tracked events or actions, associated with plays of a game. In these embodiments, the game may be any suitable game of chance, skill-based game, partial-skill-based game, or pseudo-skill-based game played as a primary game and/or a secondary (or bonus) game. In these embodiments, the system tracks events that occur as part or otherwise in association with an initiated play of a game, such as in association with one or more symbols randomly generated during a play of a game. Such tracked events qualify as ranking components that determine a user's place on one or more leaderboards associated with one or more of such tracked events.

In different embodiments, the system tracks any suitable event associated with a play of a game occurring at a gaming establishment device, such as an electronic gaming machine (“EGM”). In different embodiments, the trackable events include, but are not limited to: a quantity of plays of a game, a quantity of winning plays of a game, a quantity of losing plays of a game, an amount won playing a game, an amount lost playing one or more games, an amount of time playing a game, a total amount wagered, an amount of time between each play of each game, a quality of play (i.e., a player's skill level or how closely each player plays to optimal play), an amount of time to complete a task, a level achieved, side-wagers placed (regardless of the side-wager amount); wagers placed on a number of paylines; wagers placed on a designated payline; wagers placed on a number of ways to win; an activation of a reel (or a designated reel): an activation of a plurality of reels; a generation of any outcome (or a designated outcome); a generation of any outcome (or a designated outcome) associated with an award; a generation of any outcome (or a designated outcome) associated with an award over a designated value; a generation of an outcome (or a designated outcome) on a designated payline; a generation of an outcome (or a designated outcome) in a scatter configuration; a generation of a winning way to win (or a designated winning way to win): a generation of a losing outcome, a generation of a designated symbol or symbol combination; a generation of a designated symbol or symbol combination on a designated payline; a generation of a designated symbol or symbol combination in a scatter configuration; a generation of a losing symbol combination, a triggering of a play of a secondary game; an activation of a secondary display; an activation of a community award generator; a generation of any outcome (or a designated outcome) in a secondary game; engagements of an input device; an activation of a feature (including, but not limited to, a feature which superimposed one or more symbols over the randomly generated symbols of the reels; a feature which replaces one or more symbols of the randomly generated symbols of the reels with a predetermined symbol pattern; a feature which replaces one or more symbols of the randomly generated symbols of the reels with a predetermined pattern of wild symbols; a modifier, such as a multiplier, feature; a book-end wild symbols feature; a stacked wild symbols feature; an expanding wild symbols feature; a nudging wild symbols feature; a feature modifying a quantity of wild symbols available to be generated; a retrigger symbol feature; an anti-terminator symbol feature; a locking reel feature; an expanding reel feature; a locking symbol position feature; a feature modifying a placed wager amount; a feature modifying a placed side wager amount; a feature modifying a number of wagered on paylines; a feature modifying a wager placed on one or more paylines (or on one or more designated paylines); a feature modifying a number of ways to win wagered on; a feature modifying a wager placed on one or more ways to win (or on one or more designated ways to win); a feature modifying a paytable utilized for a play of a game; a feature modifying an average expected payback percentage of a play of a game; a feature modifying an average expected payout of a play of a game; a feature modifying one or more awards available; a feature modifying a range of awards available; a feature modifying a type of awards available; a feature modifying one or more progressive awards; a feature modifying which progressive awards are available to be won; a feature modifying one or more modifiers, such as multipliers, available; a feature modifying an activation of a reel (or a designated reel); a feature modifying an activation of a plurality of reels; a feature modifying a generated outcome (or a designated generated outcome); a feature modifying a generated outcome (or a designated generated outcome) associated with an award over a designated value; a feature modifying a generated outcome (or a designated generated outcome) on a designated payline; a feature modifying a generated outcome (or a designated generated outcome) in a scatter configuration; a feature modifying a winning way to win (or a designated winning way to win); a feature modifying a designated symbol or symbol combination; a feature modifying a generation of a designated symbol or symbol combination on a designated payline; a feature modifying a generation of a designated symbol or symbol combination in a scatter configuration; a feature modifying a quantity of picks in a selection game; a feature modifying a quantity of offers in an offer and acceptance game; a feature modifying a quantity of moves in a trail game; a feature modifying an amount of free spins provided; a feature modifying a game terminating or ending condition; a feature modifying how one or more aspects of one or more games (e.g., colors, speeds, sound) are displayed to a user) in association with one or more plays of one or more games and/or any event associated with one or more plays of one or more games of the present disclosure. In these different embodiments, the system tracks events occurring in association with any suitable game including, but not limited to: any suitable spinning reels game, any suitable wheel game; any suitable card game such as blackjack, poker or baccarat; any suitable keno game; any suitable bingo game; any suitable offer and acceptance game; any suitable award ladder game; any suitable puzzle-type game; any suitable persistence game; any suitable selection game; any suitable cascading symbols game; any suitable ways to win game; any suitable scatter pay game; any suitable coin-pusher game; any suitable elimination game; any suitable stacked wilds game; any suitable trail game; any suitable bingo game; any suitable video scratch-off game; any suitable pick-until-complete game; any suitable shooting simulation game; any suitable racing game; any suitable promotional game; any suitable high-low game; any suitable lottery game; any suitable number selection game; any suitable dice game; any suitable skill game; any suitable partial skill game; any suitable auction game; any suitable reverse-auction game; and/or any suitable group game.

In certain embodiments, one or more leaderboards correspond to one or more ranking components, such as tracked events or actions, separate from any plays of any games. In such embodiments, the system determines to track one or more events independent of any plays of any games such that one or more non-game related interactions determine the relative rankings of one or more leaderboards. For example, the system operates with a gaming establishment patron management system to track meal purchases made at one or more restaurants associated with a gaming establishment. In different embodiments, such non-game related interactions include, but are not limited to, a user visiting one or more locations of (or independent from) a gaming establishment (e.g., tracking time spent in a casino), a user not visiting a gaming establishment (i.e., tracking time spent since a last casino visit), a user making one or more purchases at one or more retail locations of (or independent from) a gaming establishment, a user making one or more designated purchases at one or more retail locations of (or independent from) a gaming establishment, a user attending one or more events at (or independent from) a gaming establishment, a user utilizing one or more gaming establishment services, a user spending a quantity of player loyalty points (e.g., player tracking points), a user placing one or more sporting event wagers, playing an online game independent of a gaming establishment device, and/or a user attending a club and/or show associated with (or independent from) a gaming establishment.

It should be appreciated that in various embodiments, the events the system tracks to determine one or more rankings on one or more leaderboards may be any suitable event which occurs in association with: (a) one or more plays of one or more primary games, (b) one or more plays of one or more secondary games, or (c) independent of any primary or secondary games played. Accordingly, any action, any inaction, and/or any decision the user makes in association with their gaming experience (either at a gaming establishment device, such as an EGM, or independent of the gaming establishment device) may be tracked and factor into the determination of one or more rankings on one or more leaderboards for that user. Such a configuration thus provides that any suitable event, regardless of how often that event occurs, may be tracked and tied to determining one or more rankings on one or more leaderboards.

In certain embodiments, the system randomly determines the event to track in association with one or more leaderboards. In certain embodiments, the system determines, based on which users are placing which wager amounts, the event to track in association with one or more leaderboards. In certain embodiments, the system determines, based on time/day, the event to track in association with one or more leaderboards. In certain embodiments, the system enables an operator of the system to determine the event to track in association with one or more leaderboards. In certain embodiments, the system enables a user, such as any user or a user having a player tracking status at or above a designated level, to determine the event to track in association with one or more leaderboards. In certain embodiments, the system enables a user to earn the ability, such as based on game play, to determine the event to track in association with one or more leaderboards. In certain embodiments, the system enables a user to purchase, with monetary funds and/or non-monetary funds (e.g., player tracking points and/or promotional credits), the ability to determine which event to track in association with one or more leaderboards.

In certain embodiments, the system randomly determines a quantity of events to track in association with one or more leaderboards. In certain embodiments, the system determines, based on which users are placing which wager amounts, a quantity of events to track in association with one or more leaderboards. In certain embodiments, the system determines, based on time/day, a quantity of events to track in association with one or more leaderboards. In certain embodiments, the system enables an operator of the system to determine a quantity of events to track in association with one or more leaderboards. In certain embodiments, the system enables a user, such as any user or a user having a player tracking status at or above a designated level, to determine a quantity of events to track in association with one or more leaderboards. In certain embodiments, the system enables a user to earn the ability, such as based on game play, to determine a quantity of events to track in association with one or more leaderboards. In certain embodiments, the system enables a user to purchase, with monetary funds and/or non-monetary funds (e.g., player tracking points and/or promotional credits), the ability to determine a quantity of events to track in association with one or more leaderboards.

In certain embodiments, the tracking of the occurrences of one or more events in association with one or more leaderboards occurs based on the satisfaction of one or more conditions. In these embodiments, the system tracks certain events if certain criteria associated with the user and/or the system are otherwise met. In certain such embodiments, a condition that needs to be met in association with the tracking of the occurrences of one or more events in association with one or more leaderboards is based on one or more metrics of a user. Such metrics include, but are not limited to, a status of the user (e.g., events are tracked for players with a player tracking account or players with a player tracking account of at least a designated status), a win rate of the user, a play rate of the user, a wagering history of the user and/or an average wager of the user. In these embodiments, if the user complies with one or more of these metrics, the system enables one or more events to be tracked to determine a ranking of a leaderboard for that user. In certain additional or alternative embodiments, a condition that needs to be met in association with the tracking of the occurrences of one or more events in association with one or more leaderboards is based on one or more properties of the gaming establishment device (e.g., events are tracked at EGMs of certain themes or certain denominations but not tracked at EGMs of other themes or other denominations).

In certain embodiments, the system determines a rank or ranking for at least one user on at least one leaderboard based on at least one of the ranking components. In these embodiments, the system positions the ranked player along a ranking scale relative to other ranked players based on the determined player ranking. In certain embodiments, the system tracks one or more events over a set period of time (and/or set quantity of games). In certain embodiments, the system tracks one or more events dynamically. That is, the system tracks one or more events during a constantly or consistently moving time period. The moving time period is represented by a moving indicator that shifts or moves over time and/or over a quantity of games played. In this embodiment, each ranking component is associated with at least one player and is tracked over the moving time period. In this embodiment, with each movement, different time units (and different ranking components) may be utilized by the system to determine the player's ranking. In certain embodiments, the leaderboard ranks players from most tracked elements to least tracked elements (e.g., players are ranked on a leaderboard such that the player with the most amount won is the highest ranked player). In certain other embodiments, the leaderboard ranks players from least tracked elements to most tracked elements (e.g., player are ranked on a leaderboard such that the player with the least amount of losing games is the highest ranked player).

In certain embodiments, after ranking the plurality of players, for each ranked position of the leaderboard, the system causes the leaderboard to display a player identifier associated with one of the plurality of players having a player ranking corresponding to that ranked position of the leaderboard. The player identifier corresponds to an identifier used to identify a player, such as a name, a handle, an EGM identifier, an account number identifier, etc.

In certain embodiments, for each player that qualifies for display on the leaderboard, the system displays additional player-related information, such as one or more of the tracked events associated with the respective player (e.g., points awarded for a play by the player, cumulative points awarded for plays by the player during a gaming session, etc.). However, it should be appreciated that the system may cause the leaderboard to display additional or alternative information, such as the amount of time that the player has been ranked and displayed on the leaderboard at their current ranked position, the amount of time that the player has been ranked and displayed on the leaderboard at any ranked position of the leaderboard, the quantity of games played by the player while ranked and displayed on the leaderboard at their current (or higher) ranked position, the quantity of games played by the player while ranked and displayed on the leaderboard at any ranked position of the leaderboard, the quantity of games that the respective player has played while they have been ranked and displayed on the leaderboard at their current (or higher) ranked position and/or the quantity of games that the respective player has played while they have been ranked and displayed on the leaderboard at any ranked position of the leaderboard.

In certain embodiments, the system communicates a notification to one or more devices of one or more users responsive to a determination of a change in the ranked positions displayed on the leaderboard. In certain embodiments, the system communicates a notification to one or more devices of one or more users responsive to a determination that a ranked position of a user on the leaderboard has moved to a lower ranked position. By communicating a notification to the device of the user, the system may motivate the user to resume playing interfacing with the gaming establishment device in an attempt to remain on the leaderboard and/or move up the leaderboard.

In certain embodiments, the system communicates a notification to any devices of any users who are negatively impacted by the change in ranked positions on the leaderboard (e.g., any user whose ranked position moved to a relatively lower ranked position on the leaderboard or who was removed from the leaderboard) and/or to any devices of any users who are positively impacted by the change in ranked positions on the leaderboard (e.g., any user whose ranked position moved to a relatively higher ranked position or who were added to the leaderboard). In certain embodiments, the system communicates a notification to devices of each of the users included on the leaderboard in response to a change in the ranked positions on the leaderboard. In certain embodiments, the system communicates a notification to devices of a subset of users who are affected by the change. In certain such embodiments, the system determines the subset of users to communicate the notifications to based on a comparison of the one or more ranking components associated with the users used to rank the users. In different embodiments, the system communicates the notification to a user via an email, a text message, a notification associated with a mobile device application, a display via an externally controlled interface of a gaming establishment device (e.g. a service window displayed by an EGM), and/or a display via any suitable display device operable to display one or more leaderboards. The notification may include information indicating to the user that the user is at risk of no longer qualifying to compete for an award and/or that the user now qualifies to compete for an award.

In certain embodiments, in addition to maintaining one or more leaderboards associated with one or more tracked events, the system maintains one or more progressive awards. In certain embodiments, the system maintains a single progressive award. In certain such embodiments, the progressive award is associated with a specific leaderboard. In certain embodiments, the progressive award is associated with a plurality of leaderboards. In certain embodiments, the progressive award is not initially associated with any leaderboards (and rather becomes associated with one or more leaderboards responsive to an occurrence of a leaderboard association event).

In certain embodiments, the progressive award is part of a plurality of progressive awards maintained in a multi-level progressive award configuration (“MLP”). In certain such embodiments, one or more of the progressive awards are each associated with a specific leaderboard. In certain embodiments, one or more of the progressive awards are each associated with a plurality of leaderboards. In certain embodiments, one or more of the progressive awards are not initially associated with any leaderboards (and rather become associated with one or more leaderboards responsive to an occurrence of a leaderboard association event). In different embodiments, the progressive award may be associated with a single gaming establishment (such that the progressive award may be considered a local area progressive (“LAP”)) or may be associated with two or more different gaming establishments (such that the progressive award may be considered a wide area progressive (“WAP”)).

In certain embodiments, the maintained progressive award is associated with a reset value utilized following a progressive award triggering event. In certain embodiments wherein the system maintains a plurality of progressive awards, each of the progressive awards have the same progressive award reset value. In certain embodiments wherein the system maintains a plurality of progressive awards, two or more of the progressive awards have different progressive award reset values.

The maintained progressive award is also associated with a progressive award contribution rate that represents, in certain instances, the portion of each wager placed (or the portion of each designated wager, such as a maximum wager, placed) that is allocated to the progressive award. In certain embodiments wherein the system maintains a plurality of progressive awards, each of the progressive awards have the same progressive award contribution rate. In certain embodiments wherein the system maintains a plurality of progressive awards, two or more of the progressive awards have different progressive award contribution rates.

In certain embodiments, the maintained progressive award is associated with a range of values, wherein the low end of the range of values represents the reset value of the progressive award and the high end of the range of values represents the maximum amount which the progressive award may reach. In these embodiments, the amount which the progressive award may be incremented to is capped or limited by the highest value in the value range associated with such progressive award. In these embodiments, the system determines a progressive award hit value from the value range associated with the progressive award and displays the current value of the progressive award and/or the maximum amount which the progressive award may reach. In other embodiments, the progressive award is not associated with any range of values. In this embodiment, the progressive award continues to be incremented until a progressive award triggering event occurs.

In addition to maintaining the progressive award, the system determines if a progressive award increment event has occurred in association with one or more of the maintained progressive awards. In one such embodiment, the progressive award increment event occurs based on (or as a result of) a wager being placed on a play of a game at an EGM associated with that award. In another such embodiment, the progressive award increment event additionally or alternatively occurs based on (or as a result of) a side wager being placed at an EGM associated with that award. In another such embodiment, the progressive award increment event additionally or alternatively occurs based on (or as a result of) one or more displayed events occurring in association with one or more plays of one or more games. In another such embodiment, the progressive award increment event occurs independent of any displayed events associated with any plays of any games. For example, a gaming establishment may periodically cause an occurrence of a progressive award increment event with funds drawn from the gaming establishment marketing department.

If the system determines that a progressive award increment event occurred in association with a progressive award, the system increases a current value of that maintained progressive award. In certain embodiments wherein the progressive award increment event occurs based on a placed wager, the increase of the maintained award is funded by a portion of the wager placed (e.g., a progressive award contribution rate of 1% of the amount of the wager placed is allocated to growing the progressive award). In certain other embodiments wherein the progressive award increment event occurs based on a placed side wager, the increase of the maintained award is funded by part or all of the side wager placed (e.g., a progressive award contribution rate of 50% of the amount of the side wager placed is allocated to growing the progressive award). In certain other embodiments, the system utilizes an amount provided by one or more marketing and/or advertising departments, such as a gaming establishment marketing department, to fund part or all of the increase of the maintained award upon an occurrence of a progressive award increment event.

In addition to increasing the progressive award (if the progressive award increment event occurs) or maintaining the progressive award (if no progressive award increment event occurs), the system determines if a progressive award triggering event has occurred. In these embodiments, in addition to periodically growing the value of one or more progressive awards, the system determines whether any event occurred (or any event failed to occur) that resulted in the availability of one or more of such progressive awards for one or more players selected from one or more leaderboards. In certain embodiments, a progressive award triggering event occurs based on one or more displayed events associated with one or more plays of one or more games. In certain embodiments, a progressive award triggering event occurs independent of any displayed events associated with any plays of any games.

In certain embodiments, upon an occurrence of a progressive award triggering event associated with a maintained progressive award, the system causes that maintained award to be made available to one or more players selected from one or more of the maintained leaderboards. In certain embodiments, a maintained award is associated with a particular leaderboard such that upon an award triggering event for that maintained award, the system selects, at least partially based on respective rankings of that particular leaderboard, a plurality of players to participate in a competition to win that maintained award. In these embodiments, responsive to an award triggering event occurring for a particular award, the system utilizes one or more ranked positions of the leaderboard associated with that award to determine which players compete against each other to win that particular award. In such embodiments, players compete in a qualifying competition with results of that qualifying competition displayed via a leaderboard to determine whether such players qualify to participate in another competition to win the award associated with that leaderboard. For example, following a determination that a progressive award triggering event occurs for a progressive award associated with a leaderboard, the system selects the players ranked in the top three ranked positions to participate in a competition sequence to win the triggered progressive award. In certain embodiments in which a maintained award is associated with a particular leaderboard, upon an award triggering event for that maintained award, the system selects, at least partially based on respective rankings of that particular leaderboard, a one or more players to win that maintained award independent of any subsequent competition.

In certain embodiments in which a maintained award that includes multiple awards, such as multiple levels of an MLP, is associated with a particular leaderboard, upon an award triggering event for that maintained award, the system selects, at least partially based on respective rankings of that particular leaderboard, a plurality of players to participate in a competition to win one or more of the awards of that maintained award. In these embodiments, responsive to an award triggering event occurring for a particular multi-component award, the system utilizes one or more ranked positions of the leaderboard associated with that multi-component award to determine which players compete against each other to win the individual components of that particular multi-component award. In such embodiments, players compete in a qualifying competition with results of that qualifying competition displayed via a leaderboard to determine whether such players qualify to participate in another competition to win the different components of the award associated with that leaderboard. For example, following a determination that a progressive award triggering event occurs for a three-level progressive award associated with a leaderboard, the system selects the players ranked in the top nine ranked positions to participate in a series of competition sequences to win the different levels of the triggered multi-level progressive award. In certain embodiments in which a maintained award that includes multiple awards, such as multiple levels of an MLP, is associated with a particular leaderboard, upon an award triggering event for that maintained award, the system selects, at least partially based on respective rankings of that particular leaderboard, a plurality of players to win the awards of that maintained award. For example, following a determination that a progressive award triggering event occurs for a progressive award having a three-level MLP configuration that is associated with a leaderboard, the system selects the players ranked in the top three ranked positions to win the respective levels of the progressive award independent of any subsequent competition.

In certain embodiments, the maintained award is not associated with any particular leaderboard such that upon an award triggering event for that maintained award, the system first selects one or more of the leaderboards and then selects, at least partially based on respective rankings of the selected leaderboards, a plurality of players to participate in a competition to win that maintained award. In these embodiments and at least in association with the occurrence of the award triggering event, the award triggering event results in the selection of one or more leaderboards to be associated with the award (i.e., an occurrence of a leaderboard association event) followed by the selection of players from the selected leaderboards (i.e., an occurrence of a ranked player selection event).

In certain embodiments, a maintained award is not associated with a particular leaderboard such that upon an award triggering event for that maintained award, the system selects a single leaderboard and then selects, at least partially based on respective rankings of that selected leaderboard, a plurality of players to participate in a competition to win that maintained award. In these embodiments, responsive to an award triggering event occurring for a particular award, the system selects a leaderboard and then utilizes one or more ranked positions of the selected leaderboard to determine which players compete against each other to win that particular award. For example, following a determination that a progressive award triggering event occurs for a progressive award not associated with any leaderboards, the system selects a leaderboard and then selects the players ranked in the top five ranked positions of the selected leaderboard to participate in a competition sequence to win the triggered progressive award. In certain embodiments in which a maintained award is not initially associated with any leaderboards, upon an award triggering event for that maintained award, the system selects a leaderboard and then selects, at least partially based on respective rankings of that selected leaderboard, a one or more players to win that maintained award independent of any subsequent competition.

In certain embodiments, a maintained award is not associated with a particular leaderboard such that upon an award triggering event for that maintained award, the system selects a plurality of leaderboards and then selects, at least partially based on respective rankings of the selected leaderboards, a plurality of players to participate in a competition to win that maintained award. In these embodiments, responsive to an award triggering event occurring for a particular award, the system selects multiple leaderboards and then utilizes one or more ranked positions of the group of selected leaderboards to determine which players compete against each other to win that particular award. For example, following a determination that a progressive award triggering event occurs for a progressive award not associated with any leaderboards, the system selects three leaderboards and then selects the players ranked in the top ranked position of each of the three selected leaderboards to participate in a competition sequence to win the triggered progressive award. In certain embodiments in which a maintained award is not initially associated with any leaderboards, upon an award triggering event for that maintained award, the system selects a plurality of leaderboard and then selects, at least partially based on respective rankings of that selected leaderboard, a one or more players to win that maintained award independent of any subsequent competition.

In certain embodiments in which a maintained award that includes multiple awards, such as multiple levels of an MLP, is not associated with any leaderboards, upon an award triggering event for that maintained award, the system selects a plurality of leaderboards and then selects, at least partially based on respective rankings of that particular leaderboard, a plurality of players to participate in a competition to win one or more of the awards of that maintained award. In these embodiments, responsive to an award triggering event occurring for a particular multi-component award, the system selects a plurality of leaderboards and then utilizes one or more ranked positions of the selected leaderboards to determine which players compete against each other to win the individual components of that particular multi-component award. For example, following a determination that a progressive award triggering event occurs for a four-level progressive award not initially associated with any leaderboards, the system selects three leaderboards and then selects players ranked in the top three ranked positions of each selected leaderboard to participate in a series of competition sequences to win the different levels of the triggered multi-level progressive award.

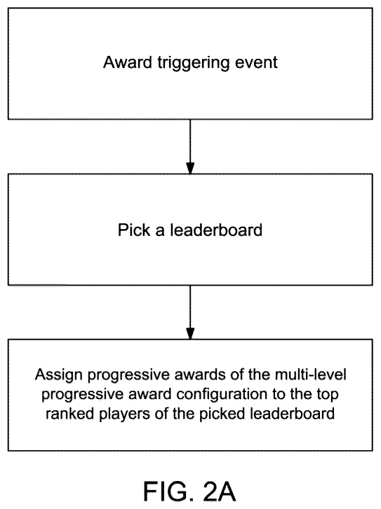

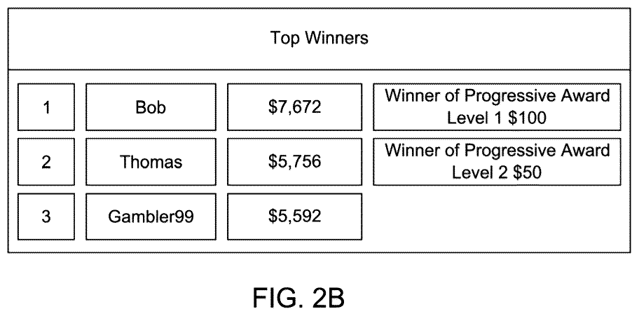

In certain embodiments in which a maintained award that includes multiple awards, such as multiple levels of an MLP, is not associated with any leaderboards, upon an award triggering event for that maintained award, the system selects a plurality of leaderboards and then selects, at least partially based on respective rankings of the selected leaderboards, a plurality of players to win the awards of that maintained award. For example, as seen in FIG. 2A, responsive to an occurrence of an award triggering event associated with a plurality of progressive awards of an MLP configuration, the system picks a leaderboard from the plurality of maintained leaderboards and assigns the different levels of the MLP configuration to the top ranked players of the selected leaderboard. In such an example, as seen in FIG. 2B, following the selection of a leaderboard and the assignment of awards to one or more players currently associated with one or more ranked positions of the selected leaderboard, the system causes one or more display devices to display which players won which awards.

In certain embodiments, the system selects one or more leaderboards to associate with a progressive award based on one or more displayed events occurring in association with one or more plays of one or more games. In certain embodiments, the system selects one or more leaderboards to associate with a progressive award based on a specific player achieving a certain outcome, such as obtaining one of more outcomes associated with a specific win category (e.g., winning a royal flush). In certain other embodiments, the system selects one or more leaderboards to associate with a progressive award based on a specific player winning a certain amount from a play of a single game or winning a certain amount over a period of time. In certain other embodiments, the system selects one or more leaderboards to associate with a progressive award based on a specific player maintaining an active gaming session for a certain amount of time and/or over a certain quantity of games played. In certain embodiments, different players have different probabilities of being involved in the selection of a leaderboard. In certain such embodiments, a player's status (as determined by a gaming establishment patron management system, such as a player tracking system) at least partially determines a probability of that player being involved in the selection of a leaderboard. In these embodiments, different players of different statuses are associated with different probabilities of being involved in the selection of a leaderboard. In certain embodiments, the system selects one or more leaderboards based on a certain game being played (e.g., a progressive award triggering event is associated with a play of a poker game such that the system selects one or more leaderboards that track occurrences associated with plays of poker games).

In certain embodiments, the system selects one or more leaderboards to associate with a progressive award independent of any displayed events associated with any plays of any games. In one embodiment, the system randomly selects one or more leaderboards to associate with a progressive award. In certain embodiments, each leaderboard has the same probability of being selected. In certain embodiments, different leaderboards have different probabilities of being selected. In such embodiments, one or more attributes of the leaderboard (e.g., which event is being tracked) factor into the probability of that leaderboard being selected.

In certain embodiments, one or more actions (or inactions) undertaken by a player at least partially determines the selection of one or more leaderboards. In certain embodiments, the system selects one or more leaderboards to associate with a progressive award based on an amount of activity associated with a particular leaderboard. For example, the system selects the leaderboard with the longest time in play. In another example, the system selects the most active leaderboard. In another example, the system selects a leaderboard with the most (or least) number of ranked players.

In another embodiment, the system selects one or more leaderboards to associate with a progressive award as part of a gaming establishment promotion. In another embodiment, the system selects one or more leaderboards to associate with a progressive award based on a specific player purchasing such an association using one or more of an amount of funds, an amount of virtual currency and/or an amount of player tracking points. In one such embodiment, the system selects one or more leaderboards to associate with a progressive award based on a player purchasing such an association for a static fee (in the form of an amount of funds, an amount of virtual currency and/or an amount of player tracking points). In another such embodiment, the system selects one or more leaderboards to associate with a progressive award based on a player purchasing such an association for a dynamic fee (in the form of an amount of funds, an amount of virtual currency and/or an amount of player tracking points).

In another embodiment, the system selects one or more leaderboards to associate with a progressive award based on a current state of a gaming establishment. For example, upon the system determining that gaming activity at a gaming establishment is currently lower than expected, the system selects a leaderboard with the most number of players on it that are actively engaging in gaming sessions at the gaming establishment.

In certain embodiments, following the selection, if any, of a leaderboard and the selection of a plurality of players currently occupying a plurality of ranked positions of the leaderboard, the system proceeds to a sequence in which the selected players compete against each other to win the triggered award. In these embodiments, while a player's relative leaderboard ranking determines whether or not they qualify to compete for a triggered award, such a leaderboard ranking does not completely determine whether or not the player wins the triggered award. In different embodiments, the system selects at least a minimum quantity of players (based on their respective ranked positions on one or more leaderboards) to participate in the competition in which the quantity of players selected to compete is a static quantity, a randomly determined quantity, a quantity based on a number of levels of a triggered MLP, a quantity based on a number of players available, based on a time of day and/or based on a historic amount of play associated with the triggering of the award.

In certain embodiments, the competition between the selected players includes one or more plays of one or more games in which the outcomes of the plays of the games determine the winner of the competition. In these embodiments, the selected players enter a head-to-head competition in which the selected player that prevails, such as the selected player that wins the most amount after each player is plays ten plays of a game, wins the triggered award. For example, the selected players each enter a slot tournament that ends after a certain amount of time (or a certain total won, a certain win amount being achieved or a certain win category being achieved) with the winner of the slot tournament winning the triggered award. It should be appreciated that any game of the present disclosure offered in any competitive format may be employed to determine which of the selected player(s) win the award upon the occurrence of the award triggering event.

In certain embodiments, in addition to utilizing one or more leaderboards to determine which users qualify to participate in one or more competitions for a particular award, responsive to an award triggering event occurring for a particular award, the system utilizes one or more ranked positions of one or more leaderboards to determine one or more attributes of the ensuing competition. In these embodiments, for the triggered competition for a particular award, a user's respective ranking on a leaderboard correlates to an advantage to that user (and/or a disadvantage of another user) for the competition. For example, the triggered competition is a group race event, wherein each user's relative ranking on one or more leaderboards correlates to that user's relative starting position in the group race event. In another such embodiment, the triggered competition is a group accumulation event, wherein each user's relative ranking on one or more leaderboards correlates to that user's relative starting accumulation value in the group accumulation event. In this embodiment, a user with a higher ranking on one or more leaderboards has a greater probability of being the first user to reach an accumulation value threshold and winning the competition. As such, in various embodiments, a user's activities (and/or lack of activities) interfacing with one or more gaming establishment devices correlates to a user's ranking on one or more leaderboards which correlates to an advantage to that user for the triggered competition. In other words, the initial state of the competition is based on the leaderboard rankings of the selected players in which the system provides certain higher ranked qualifying players an advantage (and/or providing certain lower ranking qualifying players a disadvantage). Such a configuration thus provides certain users a more visual and more intuitive competitive experience since the user knows that if they achieve (and maintained) a certain ranking on one or more leaderboards, they will be provided a tangible and relatively easily ascertainable advantage in a triggered competition that they qualify to participate in.

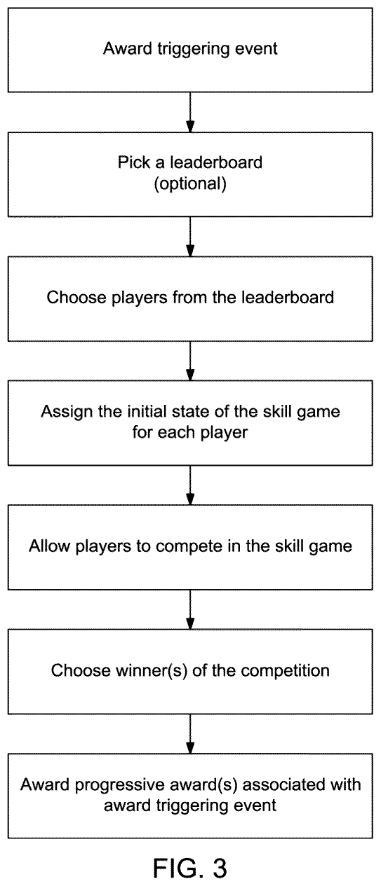

In certain embodiments, in addition to utilizing one or more leaderboards to determine which users qualify to participate in one or more competitions for a particular award, responsive to an award triggering event occurring for a particular award, the system utilizes one or more ranked positions of one or more leaderboards to determine each user's odds of winning that particular award in the ensuing competition. For example, Player A enters the competitive sequence as the top ranked player on the leaderboard and Player B enters the competitive sequence as the second ranked player on the leaderboard. In this example, Player A plays the competitive sequence with a more lucrative paytable than the paytable that Player B plays during the competitive sequence (e.g., Player A plays the sequence with a paytable that returns 150% wagered to players while Player B plays the sequence with a paytable that returns 125% wagered to players). As illustrated in this example and as seen in FIG. 3, a player's respective ranking on a leaderboard at a given point in time not only earn them the opportunity to play for a triggered award but also provide them an advantage (or provide others a disadvantage) in such a competitive opportunity.

In certain embodiments, the degree of the advantage provided to one selected player over another selected player is based on such selected players relate on one or more leaderboards. In such embodiments, the advantage (and/or disadvantage) is proportional to the difference between the rankings of the selected players. Continuing with the above example, if Player A enters the competitive sequence with 100 winning plays on a leaderboard that tracks winning plays, and Player B enters the competitive sequence with 97 winning plays, the paytables employed for both players will be relatively similar (e.g., Player A plays the sequence with a paytable that returns 150% wagered to players while Player B plays the sequence with a paytable that returns 148% wagered to players). On the other hand, if Player A enters the competitive sequence with 100 winning plays on a leaderboard that tracks winning plays, and Player B enters the competitive sequence with 50 winning plays, the paytables employed for both players will be relatively dissimilar (e.g., Player A plays the sequence with a paytable that returns 150% wagered to players while Player B plays the sequence with a paytable that returns 100% wagered to players).

In certain embodiments, the competition includes an element of skill (or partial skill) that at least partially determines the winner of the competition (and thus the winner of the triggered award). In these embodiments, for the triggered competition, the system enables each selected player to make one or more quantifiable skill inputs. A player's skill is determined and quantified by zero, one or more inputs by the player. These determined and quantified inputs tend to measure one or more aspects of the player's skill. It should be appreciated that for purposes of this application, skill includes: (i) physical skill, such as, but not limited to: timing, aim, physical strength or any combination thereof which is quantifiable by zero, one or more inputs made by the player in association with the skill-based game; (ii) mental skill (i.e., knowledge, reasoning, and/or strategy) which is quantifiable by zero, one or more inputs made by the player in association with the skill-based game; and (iii) any other type of skill which is quantifiable by zero, one or more inputs made by the player in association with the skill-based game.

In various embodiments, the player utilizes one or more skill input devices to make one or more quantifiable skill inputs. Examples of skill input devices include, but are not limited to: joysticks, buttons, a mouse or a plurality of mice, one or more trackballs, one or more pointing devices, one or more bodily motion trackers such as motion sensing devices for human-computer interaction, touchpads, touchscreens, one or more controllers with: (1) one or more motion sensing devices, (2) one or more proximity sensing devices, (3) one or more force sensing devices (transducers), (4) one or more accelerometers, or any other suitable skill input devices. By making one or more quantifiable skill inputs, the selected player manipulates, influences or otherwise controls one or more aspects of the skill-based game (and thus influences or otherwise affects the outcome of the skill-based game). For example, following the determination that the three players currently associated with the top three ranked positions of a leaderboard enter a skill game, the system enables each player to make one or more quantifiable skill inputs in the skill game such that the winner of the skill game is awarded the top progressive award of an MLP, the second-place player wins the second progressive award level of the MLP and the final player wins the third progressive award level of the MLP.

In certain embodiments, in addition to utilizing one or more leaderboards to determine which players qualify to participate in one or more skill competitions for a particular award, responsive to an award triggering event occurring for a particular award, the system utilizes one or more ranked positions of one or more leaderboards to determine any advantages (and/or disadvantages) provided to each player in the skill-based competition to win that particular award. That is, the initial state of the skill-based competition is based on the leaderboard rankings. In these embodiments, by providing certain higher ranked qualifying players an advantage (and/or providing certain lower ranking qualifying players a disadvantage), the system factors in each player's relative leaderboard ranking to at least partially influence how the skill-based competition unfolds. For example, Player A enters the competitive skill game as the top ranked player on the leaderboard and Player B enters the competitive skill game as the second ranked player on the leaderboard. In this example, Player A and Player B participate in a skill game where the players make inputs to accumulate game elements. Since Player A entered the competitive skill game as the top ranked player, the system provides Player A an advantage. In certain instances, the system provides an advantage to one or more players over other players (e.g. Player A has to accumulate less game elements than Player B or Player A begins the competitive skill game with a quantity of accumulated game elements). In certain instances, the system additionally or alternatively provides a disadvantage to one or more players relative to other players (e.g. Player B has to accumulate more game elements than Player A). As illustrated in this example, a player's respective ranking on a leaderboard at a given point in time not only earn them the opportunity to play for a progressive award but also garner them an advantage in such an opportunity.

In certain embodiments, the degree of the advantage provided to one selected player over another selected player is based on such selected players relate on one or more leaderboards. In such embodiments, the advantage (and/or disadvantage) is proportional to the difference between the rankings of the selected players. Continuing with the above example, if Player A enters the competitive skill game with $1,000 wagered on a leaderboard of total wager amount, and Player B enters the competitive skill game with $999.00, the quantity of accumulated game elements Player A begins the skill game with is relatively small. On the other hand, if Player A enters the competitive skill game with $1,000 wagered on a leaderboard of total wager amount, and Player B enters the competitive skill game with $500 wagered, the quantity of accumulated game elements Player A begins the skill game with is relatively large. It should be appreciated that any suitable advantage and/or disadvantage, such as, but not limited to, game play speed, denomination, wagering configuration, multipliers, number of reels, card decks to use, winning combinations, and/or enabled paylines, which causes one selected player to have a better (and/or worse) chance of winning the competition may be employed.

In certain embodiments, the system enables each qualifying user to participate in the competition individually. In certain such embodiments, the competition includes one or more plays of one or more head-to-head games in which two qualifying players compete. In certain embodiments, the system enables each qualifying user to participate in the competition as part of a team or group of participants. In certain such embodiments, the competition includes one or more plays of one or more head-to-head games in which two teams of qualifying players compete. In certain embodiments, the system randomly forms the two teams from qualifying players on one or more leaderboards. In certain embodiments, the system forms the two teams by picking from alternating qualifying players from one or more leaderboards (e.g., for a competition with two teams of two qualifying players per team, the system forms team one from the first and third highest ranked players from a leaderboard and forms team two from the second and fourth highest ranked players from the same leaderboard. In certain embodiments, the system enables one or more players to pick the teams (e.g., the system enables the highest ranked player on a leaderboard to pick one or more teammates from the group of other qualifying players from the leaderboard).

It should be appreciated that while the triggered award is generally described as a progressive award, any suitable award, such as any monetary benefit and/or any non-monetary benefit, may be provided to one or more of the selected players of one or more leaderboards. In different embodiments, one or more awards include one or more of: a quantity of monetary credits, a quantity of non-monetary credits, a quantity of promotional credits, a quantity of player tracking points, an amount of virtual currency, an amount of cryptocurrency (e.g., 1 Satoshi), a modifier, such as a multiplier, a quantity of free plays of one or more games, a quantity of plays of one or more secondary or bonus games, a multiplier of a quantity of free plays of a game, one or more lottery based awards, such as lottery or drawing tickets, a wager match for one or more plays of one or more games, an increase in the average expected payback percentage for one or more plays of one or more games, one or more comps, such as a free dinner, a free night's stay at a hotel, a high value product such as a free car, one or more bonus credits usable for online play, a lump sum of player tracking points or credits, a multiplier for player tracking points or credits, an increase in a membership or player tracking level, one or more coupons or promotions usable within and/or outside of the gaming establishment (e.g., a 20% off coupon for use at a convenience store), a coupon for a reduced good, a coupon for a reduced service, a coupon for a complimentary good, a coupon for a complimentary service, virtual goods associated with the system, virtual goods not associated with the system, and/or an access code usable to unlock content on an internet.

In certain embodiments, the award made available to one or more of the selected players of one or more leaderboards includes a play of a secondary game, such as a free spins game. In different embodiments, the award made available to one or more of the selected players of one or more leaderboards includes a play (e.g., a free play) of any suitable game, including, but not limited to: a play of any suitable slot game; a play of any suitable nudging wild symbol game, a play of any suitable expanding wild symbol game, a play of any suitable wheel game, a play of any suitable card game, a play of any suitable multi-hand card game, a play of any suitable offer and acceptance game, a play of any suitable award ladder game, a play of any suitable puzzle-type game, a play of any suitable persistence game, a play of any suitable selection game, a play of any suitable cascading symbols game, a play of any suitable ways to win game, a play of any suitable scatter pay game, a play of any suitable coin-pusher game, a play of any suitable elimination game, a play of any suitable stacked wilds game, a play of any suitable trail game, a play of any suitable bingo game, a play of any suitable video scratch-off game, a play of any suitable pick-until-complete game, a play of any suitable shooting simulation game, a play of any suitable racing game, a play of any suitable promotional game, a play of any suitable high-low game, a play of any suitable lottery game, a play of any suitable number selection game, a play of any suitable dice game, a play of any suitable skill game, a play of any suitable auction game, a play of any suitable reverse-auction game, a play of any suitable group game, a play of any suitable game in a service window, a play of any suitable game on a mobile device, and/or a play of any suitable game of the present disclosure.

In various embodiments, the award made available to one or more of the selected players of one or more leaderboards additionally or alternatively includes an activation of one or more features which, if activated, modifies one or more components, aspects, or elements of a play of a game, such as modifies a game outcome (e.g., the symbols evaluated for the play of the game), modifies the paytable utilized for the play of the game and/or modifies any award determined for the play of the game. In different embodiments, such features include, but are not limited to: a modifier, such as a multiplier, feature; a feature modifying a placed wager amount; a feature modifying a placed side wager amount; a feature modifying a number of wagered on paylines; a feature modifying a wager placed on one or more paylines (or on one or more designated paylines); a feature modifying a number of ways to win wagered on; a feature modifying a wager placed on one or more ways to win (or on one or more designated ways to win); a feature modifying a paytable utilized for a play of a game; a feature modifying an average expected payback percentage of a play of a game; a feature modifying an average expected payout of a play of a game; a feature modifying one or more awards available; a feature modifying a range of awards available; a feature modifying a type of awards available; a feature modifying one or more progressive awards; a feature modifying which progressive awards are available to be won; a feature modifying one or more modifiers, such as multipliers, available; a feature modifying a generated outcome (or a designated generated outcome); a feature modifying a generated outcome (or a designated generated outcome) associated with an award over a designated value; a feature modifying a generated outcome (or a designated generated outcome) on a designated payline; a feature modifying a generated outcome (or a designated generated outcome) in a scatter configuration; a feature modifying a winning way to win (or a designated winning way to win); a feature modifying a designated symbol or symbol combination; a feature modifying a generation of a designated symbol or symbol combination on a designated payline; a feature modifying a generation of a designated symbol or symbol combination in a scatter configuration; a feature modifying a quantity of picks in a selection game; a feature modifying a quantity of offers in an offer and acceptance game; a feature modifying a quantity of moves in a trail game; a feature modifying an amount of free spins provided; a feature modifying a game terminating or ending condition; a feature modifying how one or more aspects of one or more games (e.g., colors, speeds, sound) are displayed to a player; and/or a feature modifying any game play feature associated with any play of any game of the present disclosure.

In various embodiments, the award made available to one or more of the selected players of one or more leaderboards additionally or alternatively includes any suitable feature that represents, if activated, an additional award independent of the play of the game and/or an opportunity to win an additional award independent of the play of the game. In different embodiments, such features include, but are not limited to: a feature that triggers a secondary or bonus game; a feature that provides an additional award amount to a player; a feature modifying an amount of credits of a credit balance; a feature modifying an amount of promotional credits; a feature modifying a rate of earning player tracking points; a feature modifying a triggering event of a play of a secondary or bonus game; a feature modifying an activation of a secondary or bonus display (such as an award generator); a feature modifying a quantity of activations of a secondary or bonus display (e.g., a feature modifying a quantity of spins of an award generator); a feature modifying a quantity of sections of a secondary or bonus display (e.g., a feature modifying a quantity of sections of an award generator); a feature modifying one or more awards of a secondary or bonus display; a feature modifying an activation of a community award generator; a feature modifying a quantity of activations of a community award generator; a feature modifying a quantity of sections of a community award generator; a feature modifying one or more awards of a community award generator; and/or a feature modifying a generated outcome (or a designated generated outcome) in a secondary game.

In certain embodiments, following the determination of which qualifying player(s) win which award(s) in association with one or more leaderboards, the system modifies one or more leaderboards. For example, after the system provides one or more qualifying players a progressive award based on how such player's fared in a competition, the system resets the leaderboard to not display any player identifiers. In certain embodiments, following the determination of which qualifying player(s) win which award(s) in association with one or more leaderboards, the system modifies the player rankings of certain players on certain leaderboards. For example, after the system provides one or more qualifying players a progressive award based on how such player's fared in a competition, the system removes such qualifying players from the leaderboard(s). In certain embodiments, following the determination of which qualifying player(s) win which award(s) in association with one or more leaderboards, the system maintains one or more leaderboards and/or one or more player ranking.

It should be appreciated that in different embodiments, one or more of: a quantity of ranked positions displayed on the leaderboard; which information is displayed on the leaderboard; a quantity of tracked events used to rank the players; which tracked event(s) are used to rank the players; which awards to maintain in association with one or more leaderboards; a quantity of awards to maintain in association with one or more leaderboards; which leaderboards to associate with which awards; which awards to associate with which leaderboards; which competition to initiate to determine which qualifying players win which awards; a quantity of competitions to initiate to determine which qualifying players win which awards; and/or any determination of the present disclosure is/are predetermined, randomly determined, randomly determined based on one or more weighted percentages, determined based on a generated symbol or symbol combination, determined independent of a generated symbol or symbol combination, determined based on a random determination by the central controller, determined independent of a random determination by the central controller, determined based on a random determination at the system, determined independent of a random determination at the system, determined based on at least one play of at least one game, determined independent of at least one play of at least one game, determined based on a player's selection, determined independent of a player's selection, determined based on one or more side wagers placed, determined independent of one or more side wagers placed, determined based on the player's primary game wager, determined independent of the player's primary game wager, determined based on time (such as the time of day), determined independent of time (such as the time of day), determined based on an amount of coin-in accumulated in one or more pools, determined independent of an amount of coin-in accumulated in one or more pools, determined based on a status of the player (i.e., a player tracking status), determined independent of a status of the player (i.e., a player tracking status), determined based on one or more other determinations of the present disclosure, determined independent of any other determination of the present disclosure or determined based on any other suitable method or criteria.

In different embodiments, as described above, a leaderboard association event, a ranked player selection event, an award increment event, and/or an award triggering event occurs based on an outcome associated with one or more plays of any primary games or any secondary games. In one embodiment, such determinations are symbol driven based on the generation of one or more designated symbols or symbol combinations. In various embodiments, a generation of a designated symbol (or sub-symbol) or a designated set of symbols (or sub-symbols) over one or more plays of a primary game (and/or a secondary game) causes such conditions to be satisfied and/or one or more of such events to occur.

In different embodiments, the system does not provide any apparent reasons to the players for an occurrence of a leaderboard association event, a ranked player selection event, an award increment event, and/or an award triggering event. In these embodiments, such determinations are not triggered by an event in a primary game or based specifically on any of the plays of any primary games or any secondary games. That is, these events occur without any explanation or alternatively with simple explanations.

In one such embodiment, a leaderboard association event, a ranked player selection event, an award increment event, and/or an award triggering event occurs based on an amount of coin-in. In this embodiment, the system determines if an amount of coin-in reaches or exceeds a designated amount of coin-in (i.e., a threshold coin-in amount). Upon the amount of coin-in wagered reaching or exceeding the threshold coin-in amount, the system causes one or more of such events or conditions to occur. In another such embodiment, a leaderboard association event, a ranked player selection event, an award increment event, and/or an award triggering event occurs based on an amount of virtual currency-in. In this embodiment, the system determines if an amount of virtual currency-in wagered reaches or exceeds a designated amount of virtual currency-in (i.e., a threshold virtual currency-in amount). Upon the amount of virtual currency-in wagered reaching or exceeding the threshold virtual currency-in amount, the system causes one or more of such events or conditions to occur. In different embodiments, the threshold coin-in amount and/or the threshold virtual currency-in amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In one such embodiment, a leaderboard association event, a ranked player selection event, an award increment event, and/or an award triggering event occurs based on an amount of coin-out. In this embodiment, the system determines if an amount of coin-out reaches or exceeds a designated amount of coin-out (i.e., a threshold coin-out amount). Upon the amount of coin-out reaching or exceeding the threshold coin-out amount, the system causes one or more of such events or conditions to occur. In another such embodiment, a leaderboard association event, a ranked player selection event, an award increment event, and/or an award triggering event occurs based on an amount of virtual currency-out. In this embodiment, the system determines if an amount of virtual currency-out reaches or exceeds a designated amount of virtual currency-out (i.e., a threshold virtual currency-out amount). Upon the amount of virtual currency-out reaching or exceeding the threshold virtual currency-out amount, the system causes one or more of such events or conditions to occur. In different embodiments, the threshold coin-out amount and/or the threshold virtual currency-out amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In different embodiments, a leaderboard association event, a ranked player selection event, an award increment event, and/or an award triggering event occurs based on a predefined variable reaching a defined parameter threshold. For example, when a quantity of players have played an EGM (ascertained from a player tracking system), one or more of such events or conditions occur. In different embodiments, the predefined parameter thresholds include a length of time, a length of time after a certain dollar amount is hit, a wager level threshold for a specific device (which gaming device is the first to contribute a predetermined amount), a number of gaming devices active, or any other parameter that defines a suitable threshold.

In different embodiments, a leaderboard association event, a ranked player selection event, an award increment event, and/or an award triggering event occurs based on a quantity of games played. In this embodiment, a quantity of games played is set for when one or more of such events or conditions will occur. In one embodiment, such a set quantity of games played is based on historic data.

In different embodiments, a leaderboard association event, a ranked player selection event, an award increment event, and/or an award triggering event occurs based on time. In this embodiment, a time is set for when one or more of such events or conditions will occur. In one embodiment, such a set time is based on historic data.

In different embodiments, a leaderboard association event, a ranked player selection event, an award increment event, and/or an award triggering event occurs based upon system operator defined player eligibility parameters stored on a player tracking system (such as via a player tracking card or other suitable manner). In this embodiment, the parameters for eligibility are defined by the system operator based on any suitable criterion. In one embodiment, the system recognizes the player's identification (via the player tracking system) when the player inserts or otherwise associates their player tracking card in the EGM and/or logs into the player tracking system using a mobile device, such as a personal gaming device. The system determines the player tracking level of the player and if the current player tracking level defined by the system operator is eligible for one or more of such events or conditions. In one embodiment, the system operator defines minimum bet levels required for such events or conditions to occur based on the player's card level.

In different embodiments, a leaderboard association event, a ranked player selection event, an award increment event, and/or an award triggering event occurs based on a system determination, including one or more random selections by the central controller. For example, as described above, the system tracks all active EGMs and the wagers they placed, wherein based on the EGM's state as well as one or more wager pools associated with the EGM, the system determines whether to one or more of such events or conditions will occur. In one such embodiment, the player who consistently places a higher wager is more likely to be associated with an occurrence of one or more of such events or conditions than a player who consistently places a minimum wager. It should be appreciated that the criteria for determining whether a player is in active status or inactive status for determining if one or more of such events occur may the same as, substantially the same as, or different than the criteria for determining whether a player is in active status or inactive status for another one of such events to occur.

In different embodiments, a leaderboard association event, a ranked player selection event, an award increment event, and/or an award triggering event occurs based on a determination of if any numbers allotted to a gaming device match a randomly selected number. In this embodiment, upon or prior to each play of each gaming device, a gaming device selects a random number from a range of numbers and during each primary game, the gaming device allocates the first N numbers in the range, where N is the number of credits bet by the player in that primary game. At the end of the primary game, the randomly selected number is compared with the numbers allocated to the player and if a match occurs, one or more of such events or conditions occur.

It should be appreciated that any suitable manner of causing a leaderboard association event, a ranked player selection event, an award increment event, and/or an award triggering event to occur may be implemented in accordance with the system and method of the present disclosure. It should be further appreciated that one or more of the above-described triggers pertaining to a leaderboard association event, a ranked player selection event, an award increment event, and/or an award triggering event occurring may be combined in one or more different embodiments.

The above-described embodiments of the present disclosure may be implemented in accordance with or in conjunction with one or more of a variety of different types of systems, such as, but not limited to, those described below.

The present disclosure contemplates a variety of different systems each having one or more of a plurality of different features, attributes, or characteristics. A “system” as used herein refers to various configurations of: (a) one or more servers; (b) one or more electronic gaming machines such as those located on a casino floor; and/or (c) one or more personal gaming devices. Thus, in various embodiments, the system of the present disclosure includes: (a) one or more electronic gaming machines in combination with one or more servers; (b) one or more personal gaming devices in combination with one or more servers; (c) one or more personal gaming devices in combination with one or more electronic gaming machines; (d) one or more personal gaming devices, one or more electronic gaming machines, and one or more servers in combination with one another; (e) a single electronic gaming machine; (f) a plurality of electronic gaming machines in combination with one another; (g) a single personal gaming device; (h) a plurality of personal gaming devices in combination with one another; (i) a single server; and/or (j) a plurality of servers in combination with one another. For brevity and clarity and unless specifically stated otherwise, “EGM” as used herein represents one EGM or a plurality of EGMs, “personal gaming device” as used herein represents one personal gaming device or a plurality of personal gaming devices, and “server” as used herein represents one server or a plurality of servers.

As noted above, in various embodiments, the system includes an EGM (or personal gaming device) in combination with a server. In such embodiments, the EGM (or personal gaming device) is configured to communicate with the server through a data network or remote communication link. In certain such embodiments, the EGM (or personal gaming device) is configured to communicate with another EGM (or personal gaming device) through the same data network or remote communication link or through a different data network or remote communication link. For example, the system includes a plurality of EGMs that are each configured to communicate with a server through a data network.

In certain embodiments in which the system includes an EGM (or personal gaming device) in combination with a server, the server is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the server. The at least one processor of that EGM (or personal gaming device) is configured to execute the events, messages, or commands represented by such data or signals in conjunction with the operation of the EGM (or personal gaming device). Moreover, the at least one processor of the server is configured to transmit and receive data or signals representing events, messages, commands, or any other suitable information between the server and the EGM (or personal gaming device). The at least one processor of the server is configured to execute the events, messages, or commands represented by such data or signals in conjunction with the operation of the server. One, more than one, or each of the functions of the server may be performed by the at least one processor of the EGM (or personal gaming device). Further, one, more than one, or each of the functions of the at least one processor of the EGM (or personal gaming device) may be performed by the at least one processor of the server.

In certain such embodiments, computerized instructions for controlling any games (such as any primary or base games and/or any secondary or bonus games) displayed by the EGM (or personal gaming device) are executed by the server. In such “thin client” embodiments, the server remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the server to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the system includes an EGM (or personal gaming device) and a server, computerized instructions for controlling any primary or base games displayed by the EGM (or personal gaming device) are communicated from the server to the EGM (or personal gaming device) in a thick client configuration, and computerized instructions for controlling any secondary or bonus games or other functions displayed by the EGM (or personal gaming device) are executed by the server in a thin client configuration.

In certain embodiments in which the system includes: (a) an EGM (or personal gaming device) configured to communicate with a server through a data network; and/or (b) a plurality of EGMs (or personal gaming devices) configured to communicate with one another through a data network, the data network is a local area network (LAN) in which the EGMs (or personal gaming devices) are located substantially proximate to one another and/or the server. In one example, the EGMs (or personal gaming devices) and the server are located in a gaming establishment or a portion of a gaming establishment.

In other embodiments in which the system includes: (a) an EGM (or personal gaming device) configured to communicate with a server through a data network; and/or (b) a plurality of EGMs (or personal gaming devices) configured to communicate with one another through a data network, the data network is a wide area network (WAN) in which one or more of the EGMs (or personal gaming devices) are not necessarily located substantially proximate to another one of the EGMs (or personal gaming devices) and/or the server. For example, one or more of the EGMs (or personal gaming devices) are located: (a) in an area of a gaming establishment different from an area of the gaming establishment in which the server is located; or (b) in a gaming establishment different from the gaming establishment in which the server is located. In another example, the server is not located within a gaming establishment in which the EGMs (or personal gaming devices) are located. In certain embodiments in which the data network is a WAN, the system includes a server and an EGM (or personal gaming device) each located in a different gaming establishment in a same geographic area, such as a same city or a same state. Systems in which the data network is a WAN are substantially identical to systems in which the data network is a LAN, though the quantity of EGMs (or personal gaming devices) in such systems may vary relative to one another.

In further embodiments in which the system includes: (a) an EGM (or personal gaming device) configured to communicate with a server through a data network; and/or (b) a plurality of EGMs (or personal gaming devices) configured to communicate with one another through a data network, the data network is an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the server identifies a player before enabling that player to place any wagers on any plays of any wagering games. In one example, the server identifies the player by requiring a player account of the player to be logged into via an input of a unique username and password combination assigned to the player. The server may, however, identify the player in any other suitable manner, such as by validating a player tracking identification number associated with the player; by reading a player tracking card or other smart card inserted into a card reader (as described below); by validating a unique player identification number associated with the player by the server; or by identifying the EGM (or personal gaming device), such as by identifying the MAC address or the IP address of the Internet facilitator. In various embodiments, once the server identifies the player, the server enables placement of one or more wagers on one or more plays of one or more primary or base games and/or one or more secondary or bonus games, and displays those plays via the Internet browser of the EGM (or personal gaming device).

The server and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

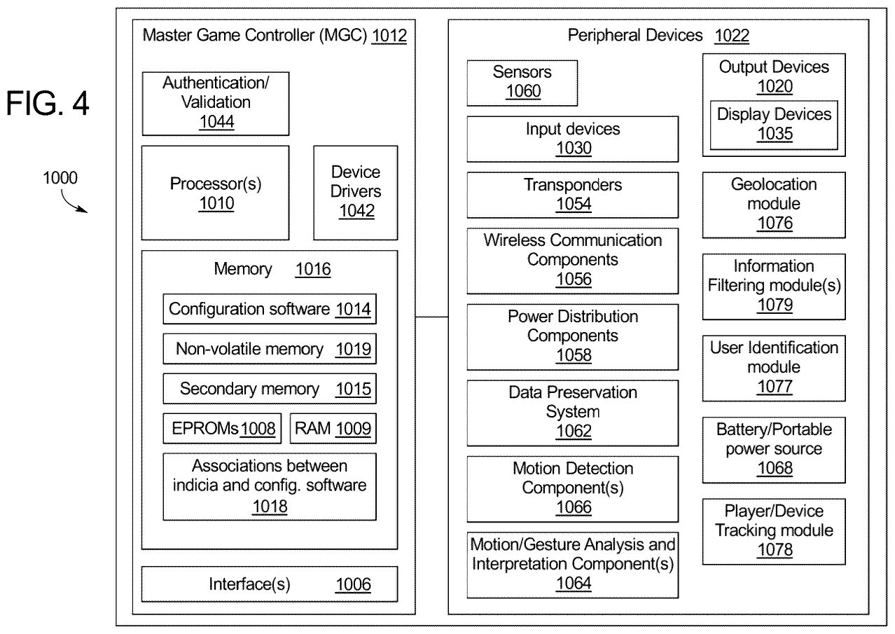

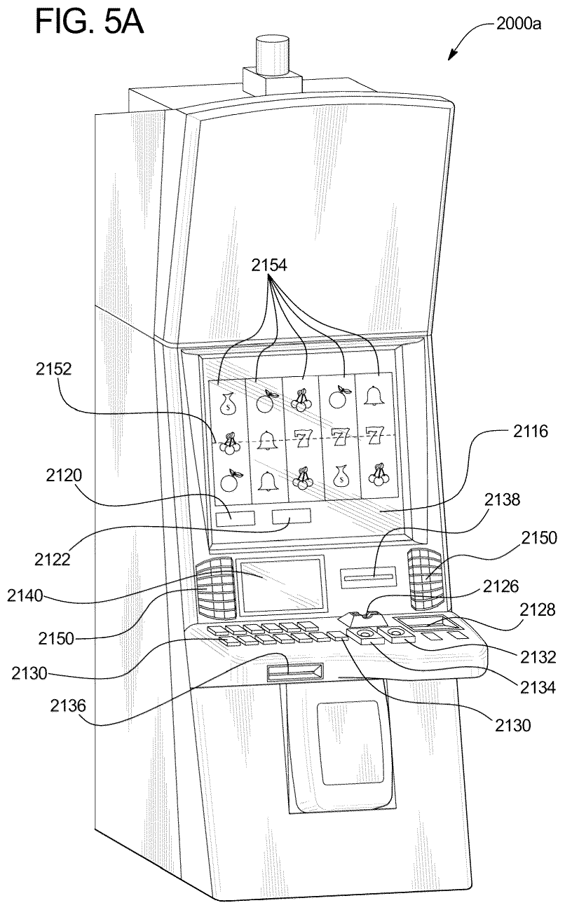

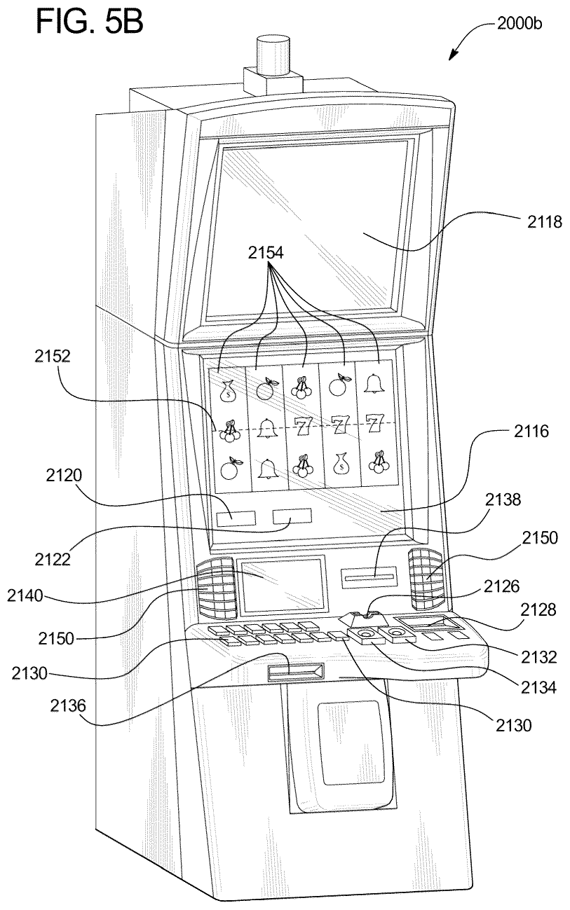

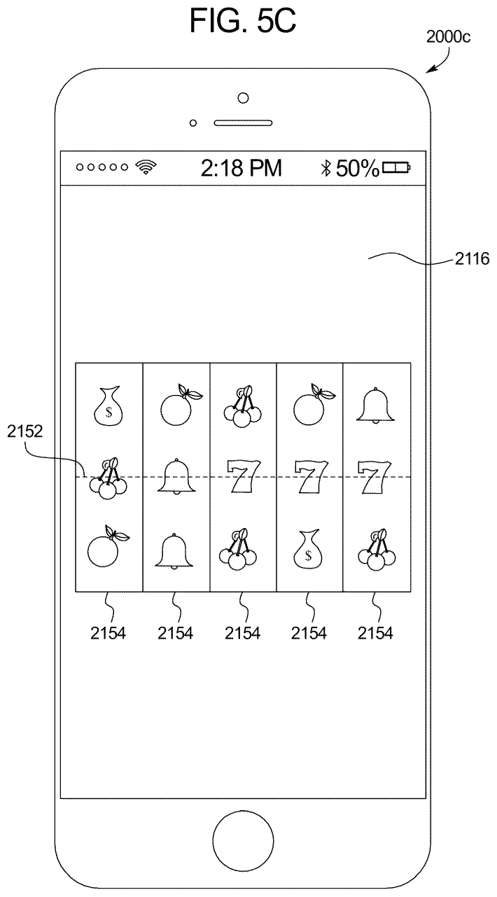

FIG. 4 is a block diagram of an example EGM 1000 and FIGS. 5A and 5B include two different example EGMs 2000a and 2000b. The EGMs 1000, 2000a, and 2000b are merely example EGMs, and different EGMs may be implemented using different combinations of the components shown in the EGMs 1000, 2000a, and 2000b. Although the below refers to EGMs, in various embodiments personal gaming devices (such as personal gaming device 2000c of FIG. 5C) may include some or all of the below components.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM of the present disclosure. In certain embodiments, the at least one memory device 1016 resides within the housing of the EGM (described below), while in other embodiments at least one component of the at least one memory device 1016 resides outside of the housing of the EGM. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 5A includes a central display device 2116, a player tracking display 2140, a credit display 2120, and a bet display 2122. The example EGM 2000b illustrated in FIG. 5B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 5A and 5B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 5A and 5B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 5A and 5B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 5A and 5B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 5A and 5B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 5A and 5B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 5A and 5B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 5A and 5B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 5A and 5B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all systems, and these example EGMs may not include one or more elements that are included in other systems. For example, certain EGMs include a coin acceptor while others do not.

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as “primary games”) and/or any secondary or bonus games or other functions (referred to herein as “secondary games”) displayed by the EGM are provided with the EGM before delivery to a gaming establishment or before being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the system includes a server and a changeable EGM, the at least one memory device of the server stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the server is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the server to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the system generates the game outcome(s) and/or the award(s) to be provided based on the associated probabilities. In these embodiments, since the system generates game outcomes and/or awards randomly or based on one or more probability calculations, there is no certainty that the system will ever provide any specific game outcome and/or award.

In certain embodiments, the system maintains one or more predetermined pools or sets of predetermined game outcomes and/or awards. In certain such embodiments, upon generation or receipt of a game outcome and/or award request, the system independently selects one of the predetermined game outcomes and/or awards from the one or more pools or sets. The system flags or marks the selected game outcome and/or award as used. Once a game outcome or an award is flagged as used, it is prevented from further selection from its respective pool or set; that is, the system does not select that game outcome or award upon another game outcome and/or award request. The system provides the selected game outcome and/or award.

In certain embodiments, the system determines a predetermined game outcome and/or award based on the results of a bingo, keno, or lottery game. In certain such embodiments, the system utilizes one or more bingo, keno, or lottery games to determine the predetermined game outcome and/or award provided for a primary game and/or a secondary game. The system is provided or associated with a bingo card. Each bingo card consists of a matrix or array of elements, wherein each element is designated with separate indicia. After a bingo card is provided, the system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the system includes a server and an EGM, the EGM is configured to communicate with the server for monitoring purposes only. In such embodiments, the EGM determines the game outcome(s) and/or award(s) to be provided in any of the manners described above, and the server monitors the activities and events occurring on the EGM. In one such embodiment, the system includes a real-time or online accounting and gaming information system configured to communicate with the server. In this embodiment, the accounting and gaming information system includes: (a) a player database configured to store player profiles, (b) a player tracking module configured to track players (as described below), and (c) a credit system configured to provide automated transactions.

As noted above, in various embodiments, the system includes one or more executable game programs executable by at least one processor of the system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the system. In certain such embodiments, the system includes one or more paylines associated with the reels. The example EGM 2000b shown in FIG. 5B includes a payline 1152 and a plurality of reels 1154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The system enables a wager to be placed on one or more of such paylines to activate such paylines. In other embodiments in which one or more paylines are formed between at least two adjacent symbol display areas, the system enables a wager to be placed on a plurality of symbol display areas, which activates those symbol display areas.

In various embodiments, the system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, the system includes a progressive award. Typically, a progressive award includes an initial amount and an additional amount funded through a portion of each wager placed to initiate a play of a primary game. When one or more triggering events occurs, the system provides at least a portion of the progressive award. After the system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the system automatically provides or initiates the secondary game upon the occurrence of a triggering event or the satisfaction of a qualifying condition. In other embodiments, the system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the system includes one or more player tracking systems. Such player tracking systems enable operators of the system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the system to begin a gaming session, the card reader reads the player identification number off the player tracking card to identify the player. The system timely tracks any suitable information or data relating to the identified player's gaming session. The system also timely tracks when the player tracking card is removed to conclude play for that gaming session. In another embodiment, rather than requiring insertion of a player tracking card into the card reader, the system utilizes one or more portable devices, such as a mobile phone, a radio frequency identification tag, or any other suitable wireless device, to track when a gaming session begins and ends. In another embodiment, the system utilizes any suitable biometric technology or ticket technology to track when a gaming session begins and ends.

In such embodiments, during one or more gaming sessions, the system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In various embodiments, the system includes one or more servers configured to communicate with a personal gaming device—such as a smartphone, a tablet computer, a desktop computer, or a laptop computer—to enable web-based game play using the personal gaming device. In various embodiments, the player must first access a gaming website via an Internet browser of the personal gaming device or execute an application (commonly called an “app”) installed on the personal gaming device before the player can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the player before enabling game play on the personal gaming device (or, in some embodiments, before enabling monetary wager-based game play on the personal gaming device). In these embodiments, the player must identify herself to the one or more servers, such as by inputting the player's unique username and password combination, providing an input to a biometric sensor (e.g., a fingerprint sensor, a retinal sensor, a voice sensor, or a facial-recognition sensor), or providing any other suitable information.

Once identified, the one or more servers enable the player to establish an account balance from which the player can draw credits usable to wager on plays of a game. In certain embodiments, the one or more servers enable the player to initiate an electronic funds transfer to transfer funds from a bank account to the player's account balance. In other embodiments, the one or more servers enable the player to make a payment using the player's credit card, debit card, or other suitable device to add money to the player's account balance. In other embodiments, the one or more servers enable the player to add money to the player's account balance via a peer-to-peer type application, such as PayPal or Venmo. The one or more servers also enable the player to cash out the player's account balance (or part of it) in any suitable manner, such as via an electronic funds transfer, by initiating creation of a paper check that is mailed to the player, or by initiating printing of a voucher at a kiosk in a gaming establishment.

In certain embodiments, the one or more servers include a payment server that handles establishing and cashing out players' account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the player's account balance can cover the desired wager (i.e., includes a monetary balance at least equal to the desired wager).

If the payment server determines that the player's account balance cannot cover the desired wager, the payment server notifies the game server, which then instructs the personal gaming device to display a suitable notification to the player that the player's account balance is too low to place the desired wager. If the payment server determines that the player's account balance can cover the desired wager, the payment server deducts the desired wager from the account balance and notifies the game server. The game server then determines an outcome and any associated award for the play of the game. The game server notifies the payment server of any nonzero award, and the payment server increases the player's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines or within the boundaries of a gaming establishment). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the system includes an EGM configured to communicate with a personal gaming device—such as a smartphone, a tablet computer, a desktop computer, or a laptop computer—to enable tethered mobile game play using the personal gaming device. Generally, in these embodiments, the EGM establishes communication with the personal gaming device and enables the player to play games on the EGM remotely via the personal gaming device. In certain embodiments, the system includes a geo-fence system that enables tethered game play within a particular geographic area but not outside of that geographic area.

In certain embodiments, the system is configured to communicate with a social network server that hosts or partially hosts a social networking website via a data network (such as the Internet) to integrate a player's gaming experience with the player's social networking account. This enables the system to send certain information to the social network server that the social network server can use to create content (such as text, an image, and/or a video) and post it to the player's wall, newsfeed, or similar area of the social networking website accessible by the player's connections (and in certain cases the public) such that the player's connections can view that information. This also enables the system to receive certain information from the social network server, such as the player's likes or dislikes or the player's list of connections. In certain embodiments, the system enables the player to link the player's player account to the player's social networking account(s). This enables the system to, once it identifies the player and initiates a gaming session (such as via the player logging in to a website (or an application) on the player's personal gaming device or via the player inserting the player's player tracking card into an EGM), link that gaming session to the player's social networking account(s). In other embodiments, the system enables the player to link the player's social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the system sends information about the award to the social network server to enable the server to create associated content (such as a screenshot of the outcome and associated award) and to post that content to the player's wall (or other suitable area) of the social networking website for the player's connections to see (and to entice them to play). In another embodiment, if a player joins a multiplayer game and there is another seat available, the system sends that information to the social network sever to enable the server to create associated content (such as text indicating a vacancy for that particular game) and to post that content to the player's wall (or other suitable area) of the social networking website for the player's connections to see (and to entice them to fill the vacancy). In another embodiment, if the player consents, the system sends advertisement information or offer information to the social network server to enable the social network server to create associated content (such as text or an image reflecting an advertisement and/or an offer) and to post that content to the player's wall (or other suitable area) of the social networking website for the player's connections to see. In another embodiment, the system enables the player to recommend a game to the player's connections by posting a recommendation to the player's wall (or other suitable area) of the social networking website.

Certain of the systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor, cause the processor to:
communicate data that results in a display, by a display device, of a plurality of leaderboards, wherein each leaderboard is associated with a different tracked event and each leaderboard comprises a plurality of ranked positions and a plurality of player identifiers that are associated, based on a ranked quantity of occurrences of the tracked event associated with that leaderboard, with the plurality of ranked positions, and
responsive to an occurrence of an award triggering event:
select a quantity of leaderboards from the plurality of leaderboards,
for each of the selected quantity of leaderboards, select a quantity of players associated with a quantity of player identifiers of the plurality of player identifiers associated with that selected leaderboard,
enable each of the selected quantity of players of each of the selected quantity of leaderboards to participate in a competition,
determine a winning player of the competition, and
communicate data that results in a display, by the display device, of an award being made available to the winning player of the competition.

2. The system of claim 1, wherein the quantity of selected leaderboards comprises at least two.

3. The system of claim 2, wherein the quantity of selected players per leaderboard is at least one.

4. The system of claim 1, wherein each of the selected leaderboards are randomly determined.

5. The system of claim 1, wherein the selected players are determined based the ranked position of each player identifier associated with each player.

6. The system of claim 1, wherein at least one of the tracked events occurs independent of any play of any game.

7. The system of claim 1, wherein the competition comprises a head-to-head competition between each of the selected quantity of players of each of the selected quantity of leaderboards.

8. The system of claim 7, wherein the head-to-head competition comprises at least one of a random determination and a skill-based determination.

9. The system of claim 1, wherein the award comprises a progressive award.

10. A system comprising:
a processor; and
a memory device that stores a plurality of instructions that, when executed by the processor, cause the processor to:
communicate data that results in a display, by a display device, of a plurality of different leaderboards, wherein each leaderboard comprises a plurality of ranked positions and a plurality of player identifiers associated with the plurality of ranked positions, and
responsive to an occurrence of an award triggering event:
select a quantity of leaderboards from the plurality of leaderboards,
for each of the selected quantity of leaderboards, select a quantity of players associated with a quantity of player identifiers of the plurality of player identifiers associated with that selected leaderboard,
enable each of the selected quantity of players of each of the selected quantity of leaderboards to participate in a competition, wherein at least one of the quantity of players is assigned an advantage in the competition, and
determine, based at least in part on the assigned advantage, a winning player of the competition, and
communicate data that results in a display, by the display device, of an award being made available to the winning player of the competition.

11. The system of claim 10, wherein each player assigned the advantage in the competition is based on at least one of the leaderboard associated with the player identifier associated with that player and the ranked position associated with the player identifier associated with that player.

12. A method of operating a system, the method comprising:
displaying, by a display device, a plurality of leaderboards, wherein each leaderboard is associated with a different tracked event and each leaderboard comprises a plurality of ranked positions and a plurality of player identifiers that are associated, based on a ranked quantity of occurrences of the tracked event associated with that leaderboard, with the plurality of ranked positions, and
responsive to an occurrence of an award triggering event:
selecting, by a processor, a quantity of leaderboards from the plurality of leaderboards,
for each of the selected quantity of leaderboards, selecting, by the processor, a quantity of players associated with a quantity of player identifiers of the plurality of player identifiers associated with that selected leaderboard,
enabling each of the selected quantity of players of each of the selected quantity of leaderboards to participate in a competition,
determining, by the processor, a winning player of the competition, and
displaying, by the display device, an award being made available to the winning player of the competition.

13. The method of claim 12, wherein the quantity of selected leaderboards comprises at least two.

14. The method of claim 13, wherein the quantity of selected players per leaderboard is at least one.

15. The method of claim 12, wherein each of the selected leaderboards are randomly determined.

16. The method of claim 12, wherein the selected players are determined based the ranked position of each player identifier associated with each player.

17. The method of claim 12, wherein at least one of the tracked events occurs independent of any play of any game.

18. The method of claim 12, wherein the competition comprises a head-to-head competition between each of the selected quantity of players of each of the selected quantity of leaderboards.

19. The method of claim 18, wherein the head-to-head competition comprises at least one of a random determination and a skill-based determination.

20. The method of claim 12, wherein the award comprises a progressive award.
